(19) United States
(12) Patent Application Publication
(10) Pub. No.: US 2018/0134576 A1
(43) Pub. Date: May 17, 2018

(54) Highly Pure Birnessite and Method for the Production Thereof

(71) Applicant: Prince Erachem SPRL, Sanit-Ghislain (BE)

(72) Inventors: Guillaume B. Rebmann, Valenciennes (FR); Oliver Schilling, Severna Park, MD (US); Jean-Bruno R. B. Soupart, Mons (BE)

(21) Appl. No.: 15/570,894

(22) PCT Filed: Jun. 21, 2016
(86) PCT No.: PCT/IB2016/053688

§ 371 Date: Oct. 31, 2017

Related U.S. Application Data
(60) Provisional application No. 62/183,015, filed on Jun. 22, 2015.

(51) Int. Cl. C01G 45/12

(52) U.S. Cl. CPC C01G 45/1221; C01P 2006/12; C01P 2006/80

(57) ABSTRACT

A method of producing an oxide of manganese including reacting, in a first aqueous solution, a manganese salt and an alkali agent to form manganese hydroxide; separating the manganese hydroxide from the first solution; mixing the manganese hydroxide into an aqueous medium to form a manganese hydroxide suspension; mixing the manganese hydroxide suspension with alkali metal hydroxide to form a second aqueous solution; and oxidizing the manganese hydroxide in the second aqueous solution to form an oxide of manganese. The dried oxide of manganese includes birnessite, a maximum of 20% hausmannite, and a maximum of 10% feitknechtite, may further include a maximum of 400 ppm of anions, may have a specific surface area of at least 25 m2/g, and may have an average oxidation state of greater than 3.5.

### CROSS REFERENCE TO RELATED APPLICATIONS

This application claims the benefit of U.S. provisional application No. 62/183,015, filed Jun. 22, 2015, which is incorporated by reference herein.

### BACKGROUND OF THE INVENTION

### Field of the Invention

This invention relates to highly pure birnessite and a method of making such highly pure birnessite.

### Description of Related Art

Birnessite is a layered manganese oxide compound where the MnO₆ octahedra form two dimensional layered structures. Cations, for example Na⁻ or K⁺, and water occupy the regions between the layers. The predominant manganese oxidation states present in birnessite are Mn (III) (Mn³⁺) and Mn (IV) (Mn⁴⁺) such that the average oxidation state (AOS) of birnessite is 3.5-4. The stacking of the Mn and oxygen ions creates an excess negative charge in the structure. The positive cations offset this excess negative charge to form a structure having electroneutrality. The spacing of the layers is approximately 7 Å, resulting in a 001 X-ray diffraction peak near 12.5° and in a 002 peak near 25° (when using Cu—Kα radiation). These two peaks provide a reference for the identification of the birnessite phase.

Because of its structure, birnessite can be used as an ion exchange material in applications such as water treatment (see Jiang et al., Removal of Ciprofloxacin from Water by Birnessite, Journal of Hazardous Materials, Apr. 15, 2013, Vol. 250-251, pages 362-369). Birnessite also has excellent catalytic properties for the catalytic oxidation of oxygenated volatile organic compounds (see Frias et al., Synthesis and Characterization of Cryptomelane- and Birnessite-Type Oxides: Precursor Effect, Materials Characterization, 2007, Vol. 58, Issue 8-9, pages 776-781). Birnessite may also be used as a curing agent for polysulphide polymer (see U.S. Pat. No. 5,026,504) and as an electrode material for chemical supercapacitors (see Athouël et al., Variation of the MnO₂ Birnessite Structure upon Charge/Discharge in an Electrochemical Supercapacitor Electrode in Aqueous Na₂SO₄ Electrolyte, Journal of Physical Chemistry C, 2008, Vol. 112, Issue 18, pages 7270-7277). In general, the higher the specific surface area (SSA) of the birnessite, the better the birnessite performs in any of these applications.

Birnessite may be made by a process including forming manganese hydroxide from a solution containing a manganese salt, for example, a nitrate, chloride, or sulfate, and a base, for example, NaOH or KOH, adding an alkali in a concentration of several moles per liter to the solution containing the manganese hydroxide, and oxidizing the manganese hydroxide using an oxidizing agent introduced into the solution. After oxidation, the resulting birnessite is filtered from the solution, washed, and dried. (See, for example, Feng et al., Synthesis of Birnessite from the Oxidation of Mn²⁺ by O₂ in Alkali Medium: Effects of Synthesis Conditions, Clays and Clay Minerals, 2004, Vol. 52. Issue 2, pages 240-250 and Yang et al., Synthesis and Characterization of Birnessite by Oxidizing Pyrochroite in Alkaline Conditions, Clays and Clay Minerals, 2002, Vol. 50, Issue 1, pages 63-69). Many oxidizing agents may be used in this process, but some, such as H₂O₂, MnO₄⁻, S₂O₈²⁻, are expensive and, therefore, not suitable for industrial production of birnessite. On the other hand, air is an inexpensive oxidizing agent which gives good results. (See, for example, Cai et al., Preparative Parameters and Framework Dopant Effects in the Synthesis of Layer-Structure Birnessite by Air Oxidation, Chemistry of Materials, 2002, Vol. 14, Issue 5, pages 2071-2077).

This conventional process for producing birnessite is shown in FIG. 1.

In this process, the manganese hydroxide is formed and oxidized in the same reactor. As such, the solution used during oxidation is the same solution used for formation of the manganese hydroxide with an addition of an alkali. The birnessite is produced in a highly alkaline solution with a large amount of salts which are byproducts of the formation and oxidation reactions, such as NaNO₃, NaCl, and Na₂SO₄. When the produced birnessite is washed, very large quantities of water are needed to dissolve and remove these undesirable salts. Once dissolved in the washing water, these salts have little or no economic value and are, therefore, discharged into the environment where they can have hazardous effects. In addition, at least a portion of these salts or anions of these salts can also remain in the birnessite as an impurity.

This conventional process of producing birnessite typically also produces hausmannite and/or feitknechtite, which are undesirable. Hausmannite is a complex oxide of Mn (II) (Mn²⁺) and Mn (III) (Mn³⁺). Hausmannite has a chemical formula of Mn304. Feitknechtite has a chemical formula of MnOOH.

### SUMMARY OF THE INVENTION

The present invention is directed to a method of producing an oxide of manganese comprising reacting, in a first aqueous solution, a manganese salt and an alkali agent to form manganese hydroxide; separating the manganese hydroxide from the first solution; mixing the manganese hydroxide into an aqueous medium to form a manganese hydroxide suspension; mixing the manganese hydroxide suspension with alkali metal hydroxide to form a second aqueous solution; and oxidizing the manganese hydroxide in the second aqueous solution to form an oxide of manganese.

The manganese salt may comprise manganese nitrate, manganese sulfate, and/or manganese chloride; the alkali agent may comprise sodium hydroxide, potassium hydroxide, and/or ammonium hydroxide; and the alkali metal hydroxide may comprise sodium hydroxide and/or potassium hydroxide. The manganese salt may be manganese nitrate; the alkali agent may be ammonium hydroxide; and the alkali metal hydroxide may be sodium hydroxide.

The first aqueous solution may comprise 20-180 grams per liter of manganese, may comprise an alkali agent comprising a hydroxide group in a concentration such that the molar ratio of the hydroxide group to manganese is in the range of 2.00-2.15, and may be maintained at a temperature of 5-40° C.

The method may further comprise washing the separated manganese hydroxide with water before forming the manganese hydroxide suspension.

The manganese hydroxide suspension may comprise 10-35 wt. % manganese. The aqueous medium may comprise water. Alternatively, the aqueous medium may be an aqueous solution comprising sodium hydroxide such that the manganese hydroxide suspension comprises 2-4 moles per liter of sodium hydroxide.

The method may further comprise milling the manganese hydroxide while the manganese hydroxide is in the manganese hydroxide suspension to obtain a manganese hydroxide particle size of 10 μm or less before adding the suspension to the alkali metal hydroxide to form the second aqueous solution.

The alkali metal hydroxide in the second aqueous solution may comprise sodium hydroxide such that the second aqueous solution comprises 1-4 moles per liter sodium hydroxide and 10-150 grains per liter of Mn and may be maintained at a temperature of 10-20° C. The manganese hydroxide may be oxidized by air, oxygen, or ozone that is introduced into the second aqueous solution.

The method may further comprise separating the oxide of manganese from the second aqueous solution and drying the oxide of manganese. An acid may be used to neutralize the oxide of manganese separated from the second aqueous solution. The drying may be conducted in air at a temperature of 80-180° C.

The dried oxide of manganese may comprise birnessite, a maximum of 20% hausmannite, and a maximum of 10% feitknechtite. The dried oxide of manganese may further comprise a maximum of 400 ppm of anions and may have a specific surface area of at least 25 m²/g.

The present invention is also directed to a dried oxide of manganese comprising birnessite, a maximum of 20% hausmannite, and a maximum of 10% feitknechtite. The dried oxide of manganese may further comprise a maximum of 400 ppm of anions. The anions may be at least one of nitrate, sulfate, and chloride. The dried oxide of manganese may have a specific surface area of at least 25 m²/g and an average oxidation state of greater than 3.5. The dried oxide of manganese may further comprise sodium.

### BRIEF DESCRIPTION OF THE DRAWINGS

FIG. 1 is a flow diagram for a prior art process for the production of birnessite;

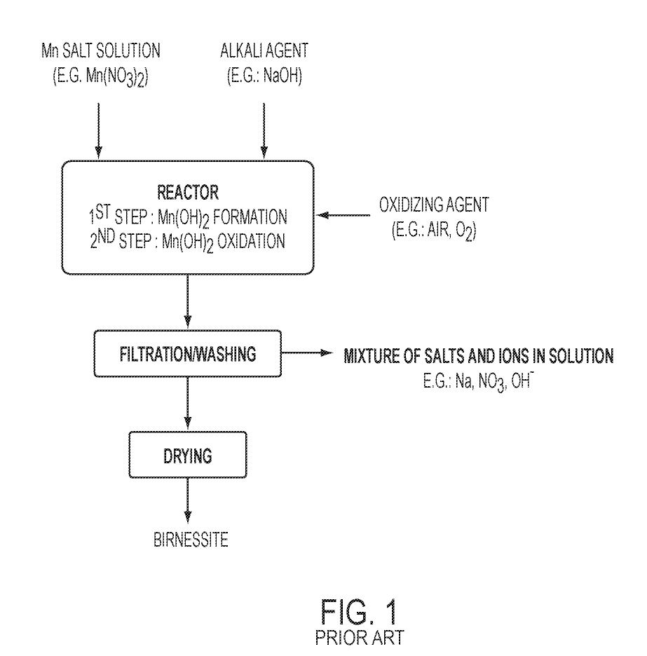

FIG. 2 is a flow diagram for the production of birnessite according to the present invention;

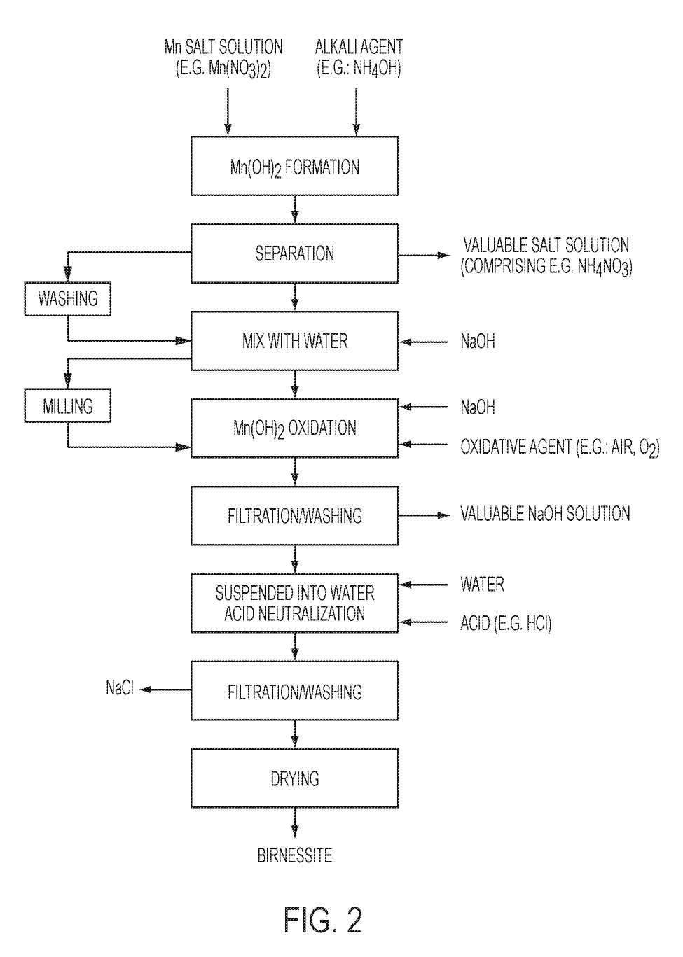

FIG. 3 is graph showing the oxidation-reduction potential and the temperature as a function of time using the oxidation of manganese hydroxide in Example 2; and

FIG. 4 is an X-ray diffraction (XRD) pattern for the dried oxide of manganese of Example 5.

### DESCRIPTION OF THE INVENTION

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1. Plural encompasses singular and vice versa. When ranges are given, any endpoints of those ranges and/or numbers within those ranges can be combined with the scope of the present invention. “Including”, “such as”, “for example” and like terms means “including/such as/for example but not limited to”.

The present invention is directed to a dried oxide of manganese comprising birnessite, 20 wt. % or less of hausmannite and 10 wt. % or less of feitknechtite, and a method of making such a highly pure oxide of manganese comprising birnessite. The dried oxide of manganese may further comprise 400 ppm or less of anions.

In accordance with one aspect of the invention, a method is provided for producing an oxide of manganese comprising birnessite; low levels of hausmannite, such as 20 wt. % or less of hausmannite or 10 wt % or less of hausmannite or 5 wt. % or less of hausmannite, or substantially free of hausmannite; and 10% or less of feitknechtite, such as 5% or less of feitknechtite or substantially free of feitknechtite. By “substantially free”, it is meant that an amount of hausmannite or feitknechtite being present is a trace impurity at most.

The oxide of manganese produced according the method of the present invention may include a maximum of 400 ppm of anions, such as 300 ppm maximum of anions.

The method comprises the steps of reacting, in a first aqueous solution, a manganese salt and an alkali agent to form manganese hydroxide; separating the manganese hydroxide from the first solution; mixing the manganese hydroxide into an aqueous medium to form a manganese hydroxide suspension; mixing the manganese hydroxide suspension with an alkali metal hydroxide to form a second aqueous solution; and oxidizing the manganese hydroxide in the second aqueous solution to form an oxide of manganese. By “aqueous medium”, it is meant water or an aqueous solution.

In a first step, manganese hydroxide (Mn(OH)₂) is formed by reacting a manganese salt and an alkali agent in a first aqueous solution. Suitable manganese salts include, but are not limited to manganese nitrate (Mn(NO₃)₂), manganese sulfate (MnSO₄), or manganese chloride (MnCl₂). The alkali agent may include a hydroxide group provided in a compound such as, but not limited to a alkali metal hydroxide (e.g., sodium hydroxide (NaOH) or potassium hydroxide (KOH)), and ammonium hydroxide (NH₄OH)).

The first aqueous solution may be made by mixing an aqueous solution of a manganese salt and an aqueous solution of an alkali agent comprising a hydroxide group to form a solution comprising up to 180 grams per liter of Mn, such as a solution comprising 5-180 grams per liter of Mn or 20-180 grams per liter of Mn or 100-180 grams per liter of Mn, and an alkali agent in sufficient quantity to yield a hydroxide group to manganese molar ratio of 2.00-2.15. The Mn concentration is kept as high as possible yet below the saturation level where the manganese salt would precipitate from the solution in the absence of an alkali agent. The saturation level, as is understood in the art, depends on the type of manganese salt and the temperature of the solution.

The aqueous solution of a manganese salt and the aqueous solution of an alkali agent may be introduced into a reactor at constant flow rates to achieve a hydroxide group to manganese molar ratio of 2.00-2.15. Mixing in the reactor may be achieved using a two blade stirrer at a stirring speed of up to 100 rpm to avoid any air entrapment. The reactor may be maintained at a temperature of 5-40° C., such as a temperature of 5-30° C. or 10-20° C. After all of the aqueous solution of a manganese salt and the aqueous solution of an alkali agent have been introduced into the reactor, stirring may be continued until the formation of manganese hydroxide has been completed, which may be for at least 20 minutes.

In accordance with one aspect of the invention, an aqueous manganese nitrate (Mn(NO₃)₂) solution and an aqueous ammonium hydroxide (NH₄OH) solution are used for the reaction in the first aqueous solution. The aqueous manganese nitrate solution may be prepared according to the teachings of U.S. Pat. No. 4,276,268 (incorporated herein by reference), and the ammonium hydroxide may be provided as a commercially available aqueous solution such as, but not limited to a solution having 25 wt. % ammonia (NH₃) in an aqueous solution. The manganese nitrate and the ammonium hydroxide in the aqueous solution react according to the reaction:

Mn(NO₃)₂+2NH₄OH→Mn(OH)₂+2NH₄NO₃

The resulting manganese hydroxide is separated from the solution by any suitable separation method, for example, vacuum filtration or press filtration. The separated manganese hydroxide may further be treated, such as by washing with water (e.g., demineralized water) to remove anions from the manganese salt, such as nitrates, sulfates, or chlorides, that may remain entrapped in the manganese hydroxide. The adequate removal of anions can be determined by measuring the conductivity of the filtrate. A conductivity of less than 1 mS/cm indicates that the manganese hydroxide has been adequately washed.

The remaining filtrate includes a salt solution, such as an ammonium nitrate solution that can be used in other chemical processing, for example, the production of fertilizers.

The separated manganese hydroxide is mixed with an aqueous medium to produce a manganese hydroxide suspension. If the aqueous medium is an aqueous solution, then this aqueous solution may comprise an alkali metal hydroxide. Suitable alkali metal hydroxides include, but are not limited to sodium hydroxide (NaOH) and potassium hydroxide (KOH). The concentration of the alkali metal hydroxide in the suspension may be at least 2 moles per liter and up to 4 moles per liter or up to 3 moles per liter. The concentration of manganese in the suspension may be at least 10 wt. %, at least 15 wt. %, or at least 20 wt. %. The concentration of manganese in the suspension may be up to 35 wt. %. The concentration of manganese in the suspension may be in the range of 10-35 wt. %, 15-35 wt. %, or 20-30 wt. %.

Optionally, the manganese hydroxide suspension may be milled using any suitable milling apparatus, for example, a ball mill, a bead mill, or an attritor mill. When a ball mill is used zirconium oxide (ZrO) or steel balls may be used for crushing the manganese hydroxide. Milling of the manganese hydroxide suspension may be continued until the manganese hydroxide particles have a median particle size, D₅₀, of 10 μm or less.

The manganese hydroxide (with or without milling) is subjected to an oxidation treatment with an oxidant such as air, oxygen alone, and/or ozone in the presence of an alkali metal hydroxide, such as sodium hydroxide (NaOH) and/or potassium hydroxide (KOH).

The manganese hydroxide suspension may be mixed with an aqueous alkali metal hydroxide solution, such as a 30 wt. % sodium hydroxide solution, to form a second aqueous solution. The resulting solution may include up to 4 moles per liter of alkali metal hydroxide and at least 1 mole per liter of alkali metal hydroxide or at least 2 moles per liter of alkali metal hydroxide or a range of alkali metal hydroxide of 1-4 moles per liter or 2-4 moles per liter. The concentration of manganese in the second aqueous solution is at least 10 grams per liter or at least 50 grams per liter and up to 150 grams per liter. As the alkali metal hydroxide concentration is increased, the formation of hausmannite is favorably reduced, but the reaction time to oxidize the manganese hydroxide is unfavorably increased. When the sodium hydroxide concentration is greater than 4 moles per liter, the reaction time to oxidize the manganese hydroxide becomes impractical. The solution may have a sodium hydroxide concentration of at east 2 moles per liter to minimize the formation of hausmannite.

The second aqueous solution is subjected to an oxidizing agent introduced into the solution and optionally dispersed through the solution by agitation. Agitation may be by stirring, for example, stirring using an impeller designed for gas dispersion, such as a rushton turbine or a CD-6 turbine. The oxidizing gas may be air, oxygen alone, and/or ozone. For example, in a 3 liter reactor with a diameter of 15 cm and a 6 cm diameter CD6 impeller, an agitation speed of 850-1200 rpm and an air flow rate of 4-12 Nl/min. (liter volume normalized to 1 atmosphere and 0° C.) may be used.

The reactor temperature is maintained at a maximum temperature of 20° C. and at least 10° C. or at least 15° C. or in a range of 10-20° C. or 15-20° C., during agitation. A cooling system may be used to keep the temperature constant within this range. If the temperature exceeds 20° C., the resulting birnessite may contain a greater amount of hausmannite.

In one embodiment, the oxide of manganese is separated from the second aqueous solution using any suitable method, for example, settling and decantation, filtration, or centrifugation. After separation, the resulting alkali metal hydroxide solution may be reused to oxidize more manganese hydroxide in a subsequent batch. The separated oxide may be washed, e.g., with demineralized water, to remove excess salts. The adequate removal of the excess salts can be determined by measuring the conductivity of the water after washing. A conductivity of less than 1 mS/cm indicates that the oxide of manganese has been adequately washed.

The oxide of manganese may be acid neutralized. For example, the oxide of manganese may be mixed into water to form a suspension having a Mn concentration of at least 10 grams per liter or at least 50 grams per liter and up to 200 grams per liter or up to 150 grams per liter or up to 100 grams per liter or a range of 50-150 grams or 50-100 grams per liter of Mn, and the pH of the suspension is lowered by adding an acid to the suspension while the suspension is being stirred. The pH may be lowered to a pH of 9 or less. Dilute hydrochloric acid (HCl) or dilute sulfuric acid (H₂SO₄) at a concentration of 0.1-3 moles per liter may be used to lower the pH of the suspension. When sufficient acid has been added, such that the solution has a pH of 9 or less, the suspension is filtered.

The oxide of manganese may be dried to form a dried oxide of manganese. Drying may be conducted in air at a temperature of at least 80° C., such as at least 100° C., and up to 180° C., such as up to 120° C. or up to 110° C. The drying temperature may be in a range of 100° C.-120° C. or 100° C.-110° C.

The global reaction that takes place during the process of the present invention, for example, is:

Mn(OH)₂+0.25(Na⁺+OH⁻)+0.418O₂→Na_{0.25}MnO_{1.96}.0.463H₂O+0.662H₂O

In accordance with one aspect of the invention, a dried oxide of manganese comprising birnessite, low levels of hausmannite, such as 20 wt. % or less of hausmannite or 10 wt. % or less of hausmannite or 5 wt. % or less of hausmannite, or substantially free of hausmannite, and at the same time low levels of feitknechtite, such as 10% or less of feitknechtite or 5% or less of feitknechtite or substantially free of feitknechtite is produced by the above-described method. The dried oxide of manganese may further comprise a maximum of 400 ppm of anions, such as a maximum of 300 ppm of anions. The anions can be introduced into the oxide of manganese from the manganese salt solution used to form the manganese hydroxide in the first step and/or from the acid used during neutralization and may be, for example, nitrate, sulfate, and chloride. The oxide of manganese has a specific surface area, as measured by the BET method, of at least 25 m²/g, for example, at least 30 m²/g.

### EXAMPLES

In the following examples, the amount of hausmannite and feitknechtite contained in the oxide of manganese, the average oxidation state of the oxide of manganese, the specific surface area (SSA) of the oxide of manganese, the anion content of the oxide of manganese, and the particle size of the manganese hydroxide were determined using the following procedures.

### Procedure for Determining the Amount of Hausmannite and Feitknechtite Contained in the Oxide of Manganese

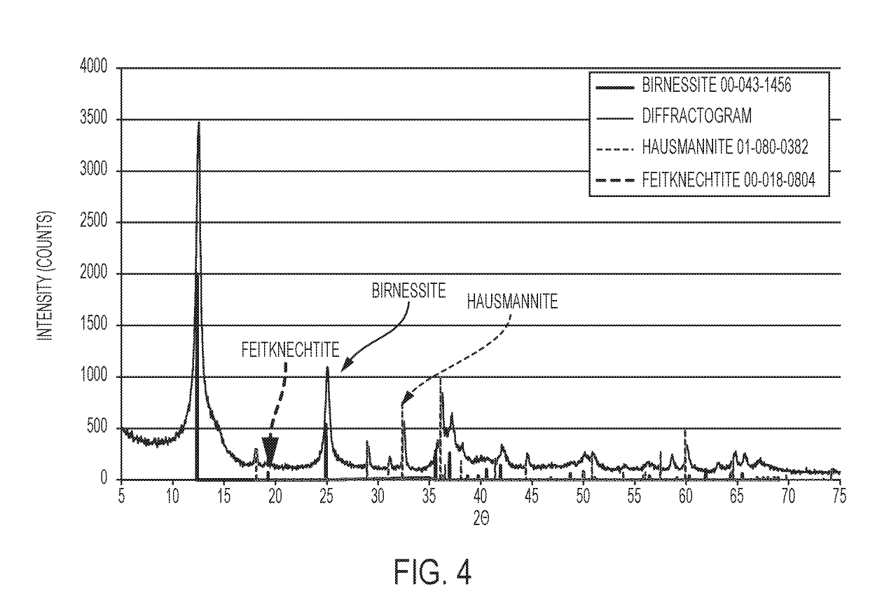

Powder X-ray diffraction was performed on the oxide of manganese with a Siemens D5000 diffractometer at 40 mA using copper-Kα radiation generated at 40 KV. The antiscatter slit was 0.1 mm and the receiving slit was 0.6 mm. The scan range extended from a scattering angle (2θ) of 5° to 75° with a step of 0.04° and a 28.8 second step time. The resulting pattern was compared to reference standards for birnessite, hausmannite, and feitknechtite as shown in FIG. 4.

Distinct peaks of birnessite, hausmannite, and feitknechtite occur at 2θ=24.91°, 2θ=32.38°, and 2θ=19.20°, respectively, with corresponding integrated net peak areas of A_{Birnessite}, A_{Hausmannite}, and A_{Feitknechtite}. The values of these net peak areas were determined using the Eva Software (version 12, rev. 0, commercialized by Brucker). By selecting a peak window of the diffractogram, the software determined a base line at the bottom of the peak and computed the net area with the trapeze method. The ratio of A_{Hausmannite}/(A_{Birnessite}+A_{Hausmannite}+A_{Feitknechtite})×100% is defined herein as the hausmannite percentage of the material. The ratio of A_{Feitknechtite}/(A_{Birnessite}+A_{Hausmannite}+A_{Feitknechtite})×100% is defined herein as the feitknechtite percentage of the material.

### Procedure for Determining the Average Oxidation State of the Oxide of Manganese

The manganese content (% Mn) of the oxide of manganese and the MnO₂ content (% MnO2) were determined using potentiometric titration with potassium permanganate after dissolution in hydrochloric acid and acidic ferrous sulfate solution, respectively (See Glover et al. (ed.), Handbook of Manganese Dioxide Battery Grade, The International Battery Material Association (IBA, Inc.), 1989, incorporated herein by reference). The average oxidation state (AOS) of the oxide of manganese was calculated from the Mn and MnO₂ contents using the following formula:

AOS=2+2×54.94/86.94×wt. % MnO₂/wt. % Mn

### Procedure for Determining Specific Surface Area of the Oxide of Manganese

The specific surface area (SSA) of the oxide of manganese was determined using the Brunauer-Emmett-Teller (BET) method. The sample was first treated at 150° C. for 60 minutes under vacuum (0.5 to 1 torr). The SSA was then determined by the absorption of nitrogen according to the BET method with a 5 points curve relative pressure measurement in the range 0-0.3 using a Micromeritics Tristar 3000.

### Procedure for Determining the Ammonia and Anion Content of the Oxide of Manganese

The ammonia and nitrate content of the oxide of manganese were determined by distillation followed by an acid-base titration. The chlorine content of the oxide of manganese was determined by a potentiometric method using silver nitrate. The sulfate content was calculated from the sulfur content determined by Inductively Coupled Plasma (ICP) analysis.

### Procedure for Determining the Particle Size of the Manganese Hydroxide

The median particle size (D₅₀) of the manganese hydroxide was determined with a Coulter LS13320 laser diffraction particle size analyzer.

### Example 1

Demineralized water (300 ml) was introduced into an agitated reactor having a volume of 4 liters. The liquid was agitated with a 2 blade stirrer at a stirring speed of 70 rpm. An aqueous manganese nitrate solution having a manganese content of 1.20 grams per liter and an aqueous ammonium hydroxide solution having an ammonia content of 230 grams NH3 per liter were simultaneously introduced into the reactor at constant flow rates for 75 minutes to produce a solution having a hydroxide group to manganese ratio of 2.05. The reactor temperature was not controlled, and it reached about 24° C. after the introduction of reactants. After introduction of the aqueous manganese nitrate solution and the aqueous ammonium hydroxide solution to the reactor was completed, stirring of the solution was continued for 20 minutes to complete the formation of manganese hydroxide.

The solution was filtered on a Buchner filter and the filter cake was washed on the filter using 3 liters of demineralized water. The filtrate was a solution of ammonium nitrate that can be beneficially used, for example, as a fertilizer.

The manganese hydroxide filter cake was suspended in demineralized water to obtain a suspension having 32.1 wt. % Mn. The median particle size of the manganese hydroxide was determined to be 53 microns.

The manganese hydroxide suspension was milled for 1 hour in a ball mill with steel balls. After milling, the median particle size (D₅₀) was 4.0 microns.

A jacketed reactor was filled with 3 liters of 3 molar sodium hydroxide solution at a temperature of 10° C. The solution was stirred at 500 rpm. The milled manganese hydroxide suspension was introduced into the reactor in an amount containing 80 g of Mn. After the introduction of the manganese hydroxide suspension, the stirring speed was increased to 850 rpm and air was introduced below the impeller at 4 Nl/min. The temperature of the reactor was controlled at 10° C.

The oxidation-reduction potential was measured using an oxidation-reduction potential probe with an Ag/AgCl reference electrode. When the potential of the solution had increased to −100 mV, the oxidation of the manganese hydroxide to form an oxide of manganese was deemed to be complete. The oxide of manganese was separated from the solution using a Buchner filter and washed on the filter with 1 liter of demineralized water. The filtrate was a solution of sodium hydroxide that could be beneficially re-used in a subsequent synthesis. The filter cake was then suspended into 1 liter of demineralized water and hydrochloric acid was added drop wise to the suspension until the pH decreased to 9. After neutralization, the oxide of manganese was filtered from the suspension and washed with 4 liters of demineralized water. The product was dried in an oven at 105° C.

The resulting oxide of manganese had an AOS of 3.48 and was characterized by powder X-ray diffraction and found to contain birnessite, hausmannite, and feitknechtite. The hausmannite content was 13% and the feitknechtite content was 4%. The resulting oxide of manganese was characterized as shown in Table 1.

### Example 2

Demineralized water (300 ml) was added into an agitated reactor having a volume of 4 liters. The liquid was agitated with a 2 blade-stirrer at a stirring speed of 25 rpm. An aqueous manganese nitrate solution having a manganese content of 120 grams per liter and an aqueous ammonium hydroxide solution having an ammonia content of 230 grams per liter were simultaneously introduced into the reactor at constant flow rates for 75 minutes to produce a solution having a hydroxide group to manganese ratio of 2.05. The reactor temperature was controlled at 20° C. After introduction of the aqueous manganese nitrate solution and the aqueous ammonium hydroxide solution to the reactor was completed, stirring of the solution was continued for 20 minutes to complete formation of manganese hydroxide.

The solution was filtered on a Buchner filter and the filter cake was washed on the filter using 3 liters of demineralized water. The filtrate was a solution of ammonium nitrate that can be beneficially used, for example, as a fertilizer.

The manganese hydroxide filter cake was suspended in a 3 molar aqueous sodium hydroxide solution to obtain a suspension having 18 wt. % Mn. The median particle size of the manganese hydroxide was determined to be about 32 microns.

The manganese hydroxide suspension was milled for 1 hour in an attritor mill with steel balls.

A jacketed reactor was filled with 2.2 liters of 3 molar sodium hydroxide solution at a temperature of 20° C. The solution was stirred at 500 rpm. The milled manganese hydroxide suspension was introduced into the reactor in an amount containing 59 g of Mn. After the introduction of the manganese hydroxide suspension, the stirring speed was increased to 1200 rpm and air was introduced below the impeller at 12 Nl/min. The temperature of the reactor was controlled at 20° C.

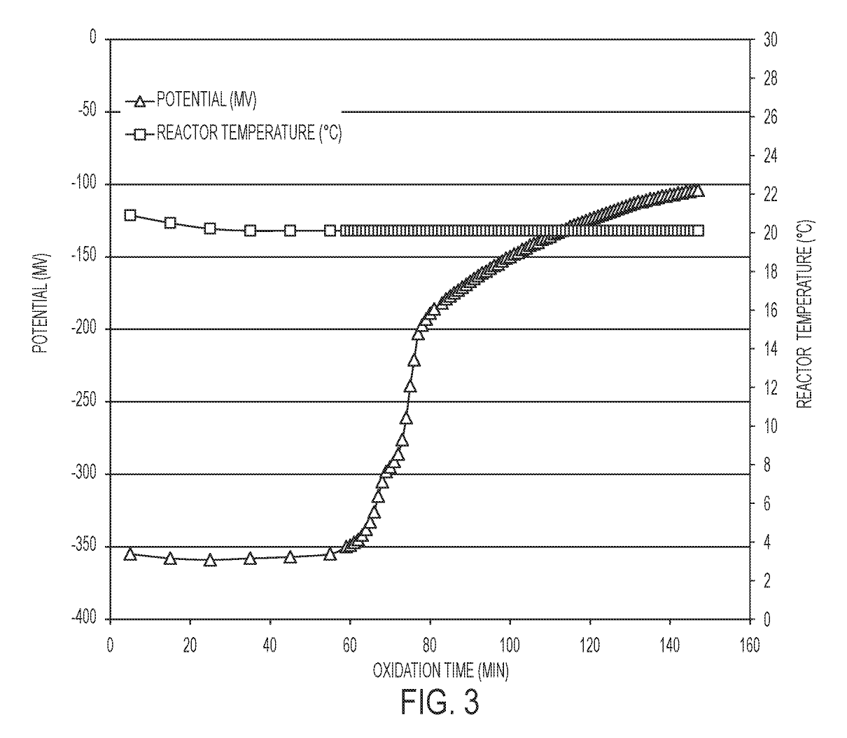

The oxidation-reduction potential was measured using an oxidation-reduction potential probe with an Ag/AgCl reference electrode. The potential and temperature as a function of time are shown in FIG. 3. When the potential of the solution had increased to −100 mV, the oxidation of the manganese hydroxide to form an oxide of manganese was deemed to be complete. The oxide of manganese was separated from the solution using a Buchner filter and washed on the filter with 1 liter of demineralized water. The filter cake was then suspended into 1 liter of demineralized water and hydrochloric acid was added drop wise to the suspension until the pH decreased to 9. After neutralization, the suspension was filtered and washed with 4 liters of demineralized water. The filtrate was a solution of sodium hydroxide that could be beneficially re-used in a subsequent synthesis. The product was dried in an oven at 105° C.

The resulting oxide of manganese was characterized as shown in Table I.

### Example 3

An oxide of manganese was produced using the same parameters as Example 2 except the sodium hydroxide concentration in the oxidation reactor was 2 moles per liter. The resulting oxide of manganese was characterized as shown in Table 1.

### Example 4

Demineralized water (300 ml) was added into an agitated reactor having a volume of 4 liters. The liquid was agitated with a 2 blade-stirrer at a stirring speed of 25 RPM. An aqueous manganese nitrate solution having a manganese content of 120 grams per liter and an aqueous ammonium hydroxide solution having an ammonia (NH₃) content of 230 grams per liter were simultaneously introduced into the reactor at constant flow rates for 75 minutes to produce a solution having a hydroxide group to manganese ratio of 2.05. The reactor temperature was controlled at 5-10° C. After introduction of the aqueous manganese nitrate solution and the aqueous ammonium hydroxide solution to the reactor was completed, stirring of the solution was continued for 20 minutes to complete formation of manganese hydroxide.

The solution was filtered on a Buchner filter and the filter cake was washed on the filter using 3 liters of demineralized water.

The manganese hydroxide filter cake was suspended in a 3 molar aqueous sodium hydroxide solution to obtain a suspension having 11.2 wt. % Mn. The median particle size of the manganese hydroxide was determined to be about 32 microns.

The manganese hydroxide suspension was milled for 1 hour in an attritor mill with steel balls.

A jacketed reactor was filled with 2.2 liters of 3 molar sodium hydroxide solution at a temperature of 10° C. The solution was stirred at 500 rpm. The milled manganese hydroxide suspension was introduced into the reactor in an amount containing 59 g of Mn. After the introduction of the manganese hydroxide suspension, the stirring speed was increased to 850 rpm and air was introduced below the impeller at 4 Nl/min. The temperature of the reactor was controlled at 10° C.

The oxidation-reduction potential was measured using an oxidation-reduction potential probe with an Ag/AgCl reference electrode. When the potential of the solution had increased to −100 mV, the oxidation of the manganese hydroxide to form an oxide of manganese was deemed to be complete. The oxide of manganese was separated from the solution using a Buchner filter and washed on the filter with 1 liter of demineralized water. The filter cake was then suspended into 1 liter of demineralized water and hydrochloric acid was added drop wise to the suspension until the pH decreased to 9. After neutralization, the suspension was filtered and washed with 4 liters demineralized water. The product was dried in an oven at 105° C.

The resulting oxide of manganese was characterized as shown in Table 1.

### Example 5

An oxide of manganese was produced using the same parameters as Example 4 except the temperature of the oxidation reactor was maintained at 20° C. The resulting oxide of manganese was characterized as shown in Table 1. The X-ray diffractogram used to determine the amount of hausmannite and feitknechtite in the oxide of manganese produced in this example is shown in FIG. 4.

### Example 6

An oxide of manganese was produced using the same parameters as Example 4 except, during the oxidation process, the temperature of the oxidation reactor was maintained at 20° C., stirring was at 1000 rpm, and 6 Nl/min of air was used. The resulting oxide of manganese was characterized as shown in Table 1.

### Example 7

An oxide of manganese was produced using the same parameters as Example 4 except, during the oxidation process, the temperature of the oxidation reactor was maintained at 20° C., stirring was at 1000 rpm, and 8 Nl/min of air was used. The resulting oxide of manganese was characterized as shown in Table 1.

### Example 8

An oxide of manganese was produced using the same parameters as Example 4 except, during the oxidation process, the temperature of the oxidation reactor was maintained at 20° C., stirring was at 1200 rpm, and 12 Nl/min of air was used. The resulting oxide of manganese was characterized as shown in Table 1.

### Comparative Example 1

An oxide of manganese was produced using the same parameters as Example 1 except the manganese hydroxide was not milled and had a particle size, D₅₀, of 53 microns. The resulting oxide of manganese was characterized as shown in Table 1.

### Comparative Example 2

A 4 liter jacketed reactor was filled with 59 g Mn as an aqueous manganese nitrate solution and 1010 g H₂O. The solution was stirred at 500 rpm. The temperature of the solution was controlled at 10° C. and 1170 g of a 30 wt. % aqueous sodium hydroxide solution was introduced into the reactor at a constant flowrate of 32 ml/min. The total volume of the aqueous sodium hydroxide solution added to the reactor was 2.2 liters resulting in a 3 moles per liter concentration of free sodium hydroxide. After the introduction of the sodium hydroxide, a suspension of manganese hydroxide in the mixture of the aqueous solutions of sodium hydroxide and sodium nitrate was obtained. The median particle size of the manganese hydroxide particles was 56 microns.

The stirring speed was increased to 850 rpm and air was introduced below the impeller at 4 Nl/min. The temperature of the reactor was controlled at 10° C.

The oxidation-reduction potential was measured using an oxidation-reduction potential probe with an Ag/AgCl reference electrode. When the potential of the solution had increased to −100 mV, the oxidation of the manganese hydroxide to form an oxide of manganese was deemed to be complete. The oxide of manganese was separated from the solution using a Buchner filter and washed on the filter with 1 liter of demineralized water. The filter cake was then suspended into 1 liter of demineralized water and hydrochloric acid was added drop wise to the suspension until the pH decreased to 9. After neutralization, the suspension was filtered and washed with 4 liters demineralized water. The filtrate was an aqueous solution of a mixture of sodium hydroxide and sodium nitrate, which has no beneficial use. The product was dried in an oven at 105° C.

The resulting oxide of manganese was characterized as shown in Table 1. While no hausmannite was detected, a significant peak at 2θ=19.25° which corresponds to Feitknechtite (β-MnOOH) was detected.

### Comparative Example 3

A 4 liter jacketed reactor was filled with 59 g Mn as an aqueous manganese sulfate solution and 980 g H₂O. The solution was stirred at 500 rpm and the temperature of the solution. The temperature of the solution was controlled at 10° C. and 1170 g of a 30 wt. % aqueous sodium hydroxide solution was introduced into the reactor at a constant flowrate of 32 ml/min. The total volume of the aqueous sodium hydroxide solution added to the reactor was 2.2 liters resulting in a 3 moles per liter concentration of free sodium hydroxide. After the introduction of the sodium hydroxide, a slurry of manganese hydroxide was obtained. The median particle size of the manganese hydroxide particles was 56 microns.

The stirring speed was increased to 850 rpm and air was introduced below the impeller at 4 Nl/min. The temperature of the reactor was controlled at 10° C.

The oxidation-reduction potential was measured using an oxidation-reduction potential probe with an Ag/AgCl reference electrode. When the potential of the solution had increased to −100 mV, the oxidation of the manganese hydroxide to form an oxide of manganese was deemed to be complete. The oxide of manganese was separated from the solution using a Buchner filter and washed on the filter with 1 liter of demineralized water. The filter cake was then suspended into 1 liter of demineralized water and hydrochloric acid was added drop wise to the suspension until the pH decreased to 9. After neutralization, the suspension was filtered and washed with 4 liters demineralized water. The filtrate was an aqueous solution of a mixture of sodium hydroxide and sodium sulfate, which has no beneficial use. The product was dried in an oven at 105° C.

The resulting oxide of manganese was characterized as shown in Table 1. While no hausmannite was detected, a significant peak at 2θ=19.25° which corresponds to Feitknechtite (β-MnOOH) was detected.

Whereas particular aspects of this invention have been described above for purposes of illustration, it will be evident to those skilled in the art that numerous variations of the details of the present invention may be made without departing from the invention as defined in the appended claims.

TABLE 1

| Example | | | | | | | | Comparative Example | | |
|---|---|---|---|---|---|---|---|---|---|---|
| 1 | 2 | 3 | 4 | 5 | 6 | 7 | 8 | 1 | 2 | 3 |

Formation of Manganese Hydroxide

| | | | | | | | | | | | |
|---|---|---|---|---|---|---|---|---|---|---|---|
| Mn Salt | Mn(NO₃)₂ | Mn(NO₃)₂ | Mn(NO₃)₂ | Mn(NO₃)₂ | Mn(NO₃)₂ | Mn(NO₃)₂ | Mn(NO₃)₂ | Mn(NO₃)₂ | Mn(NO₃)₂ | Mn(NO₃)₂ | MnSO₄ |
| Alkali Agent | NH₄OH | NH₄OH | NH₄OH | NH₄OH | NH₄OH | NH₄OH | NH₄OH | NH₄OH | NH₄OH | NaOH | NaOH |
| Hydroxide to | 2.05 | 2.05 | 2.05 | 2.05 | 2.05 | 2.05 | 2.05 | 2.05 | 2.05 | 8.2 | 8.2 |
| Manganese | | | | | | | | | | | |
| Ratio | | | | | | | | | | | |
| Agitation | 70 | 25 | 25 | 25 | 15 | 25 | 25 | 25 | 70 | 500 | 500 |
| (rpm) | | | | | | | | | | | |
| Temperature | 24 | 20 | 20 | 5-10 | 5-10 | 5-10 | 5-10 | 5-10 | 24 | 10-15 | 10-15 |
| (° C.) | | | | | | | | | | | |
| Manganese | Yes | Yes | Yes | Yes | Yes | Yes | Yes | Yes | Yes | No | No |
| Hydroxide | | | | | | | | | | | |
| Separated | | | | | | | | | | | |
| from Solution | | | | | | | | | | | |

Suspension of Manganese Hydroxide

| | | | | | | | | | | | |
|---|---|---|---|---|---|---|---|---|---|---|---|
| Mn | 32.1 | 18 | 18 | 11.2 | 11.2 | 11.2 | 11.2 | 11.2 | 32.1 | — | — |
| Concentration | | | | | | | | | | | |
| (wt. %) | | | | | | | | | | | |
| Solution | H₂O | 3M NaOH | 3M NaOH | 3M NaOH | 3M NaOH | 3M NaOH | 3M NaOH | 3M NaOH | 3M NaOH | — | — |
| Particle Size | 53 | 32 | 32 | 32 | 32 | 32 | 32 | 32 | 53 | 56 | 12 |
| (μm) | | | | | | | | | | | |

Milling

| | | | | | | | | | | | |
|---|---|---|---|---|---|---|---|---|---|---|---|
| Milled? | Yes | Yes | Yes | Yes | Yes | Yes | Yes | Yes | No | No | No |
| Particle Size | 4 | | | | | | | | | | |
| (μm) | | | | | | | | | | | |

Oxidation of Manganese Hydroxide

| | | | | | | | | | | | |
|---|---|---|---|---|---|---|---|---|---|---|---|
| Grams of Mn | 80 | 59 | 59 | 59 | 59 | 59 | 59 | 59 | 80 | 59 | 59 |
| added as | | | | | | | | | | | |
| Manganese | | | | | | | | | | | |
| Hydroxide | | | | | | | | | | | |
| Alkali Metal | 3 l of 3M | 2.2 l of | 2.2 l of | 2.2 l of | 2.2 l of | 2.2 l of | 2.2 l of | 2.2 l of | 3 l of 3M | 2.2 l of | 2.2 l of |
| Hydroxide | NaOH | 3M NaOH | 2M NaOH | 3M NaOH | 3M NaOH | 3M NaOH | 3M NaOH | 3M NaOH | NaOH | 3M NaOH | 3M NaOH |
| Solution | | | | | | | | | | | |
| Air (Nl/min.) | 4 | 12 | 12 | 4 | 4 | 6 | 8 | 12 | 4 | 4 | 4 |
| Agitation | 850 | 1200 | 1200 | 850 | 850 | 1000 | 1000 | 1200 | 850 | 850 | 850 |
| (rpm) | | | | | | | | | | | |
| Temperature | 10 | 20 | 20 | 10 | 20 | 20 | 20 | 20 | 10 | 10 | 10 |
| (° C.) | | | | | | | | | | | |

Analysis of Produced Oxide of Manganese

| | | | | | | | | | | | |
|---|---|---|---|---|---|---|---|---|---|---|---|
| Na (%) | | 7.06 | 5.85 | 6.2 | | | | | | 6.3 | 6.1 |
| Mn(%) | | 52.1 | 53.4 | 53.1 | | | | | | 53.3 | 52.9 |
| MnO₂ (%) | | 70 | 68.8 | 70.9 | | | | | | 69.4 | 68.5 |
| AOS | 3.48 | 3.70 | 3.63 | 3.69 | 3.52 | 3.58 | 3.64 | 3.69 | 2.91 | 3.65 | 3.64 |
| SSA (m²/g) | 33.1 | 41.8 | 45.7 | 46.5 | 27.2 | 32.5 | 25.6 | 43.5 | 20.9 | 21.3 | 25.5 |
| NH₃ (ppm) | | 11 | 24 | 17 | | | | | | 10 | 25 |
| NO₃ (ppm) | | 156 | 240 | 20 | | | | | | 325 | 0 |
| SO₄ (ppm) | | | | | | | | | | | 965 |
| Cl (ppm) | | 35 | 32 | 22 | | | | | | 93 | 120 |
| Hausmannite | 13 | 2 | 4 | 4 | 15 | 10 | 4 | 1 | 66 | 0 | 0 |
| (%) | | | | | | | | | | | |
| Feitknechtite | 4 | 0 | 4 | 1 | 3 | 4 | 8 | 2 | 31 | 13 | 11 |
| (%) | | | | | | | | | | | |

The invention claimed is:

1. A method of producing an oxide of manganese comprising:
reacting, in a first aqueous solution, a manganese salt and an alkali agent to form manganese hydroxide;
separating the manganese hydroxide from the first solution;
mixing the manganese hydroxide into an aqueous medium to form a manganese hydroxide suspension;
mixing the manganese hydroxide suspension with alkali metal hydroxide to form a second aqueous solution; and
oxidizing the manganese hydroxide in the second aqueous solution to form an oxide of manganese.

2. The method of claim 1, wherein the manganese salt comprises manganese nitrate, manganese sulfate, and/or manganese chloride; the alkali agent comprises sodium hydroxide, potassium hydroxide;and/or ammonium hydroxide; and the alkali metal hydroxide comprises sodium hydroxide and/or potassium hydroxide.

3. The method of claim 1, wherein the manganese salt is manganese nitrate, the alkali agent is ammonium hydroxide, and the alkali metal hydroxide is sodium hydroxide.

4. The method of claim 1, wherein the alkali agent comprises a hydroxide group and the first aqueous solution comprises 20-180 grams per liter of manganese and a molar ratio of the hydroxide group to manganese of 2.00-2.15.

5. The method of claim 1, wherein the first solution is maintained at a temperature of 5-40° C.

6. The method of claim 1, wherein the manganese hydroxide suspension comprises 10-35 wt. % manganese.

7. The method of claim 1, wherein the aqueous medium is an aqueous solution that comprises sodium hydroxide and the manganese hydroxide suspension comprises 2-4 moles per liter of sodium hydroxide.

8. The method of claim 1, wherein the alkali metal hydroxide in the second aqueous solution comprises sodium hydroxide and the second aqueous solution comprises 1-4 moles per liter sodium hydroxide and 10-150 grams per liter of Mn.

9. The method of claim 1, wherein the manganese hydroxide is oxidized by air, oxygen, or ozone that is introduced into the second aqueous solution.

10. The method of claim 1, herein the second aqueous solution is maintained at a temperature of 10-20° C.

11. The method of claim 1, further comprising washing the separated manganese hydroxide with water before forming the manganese hydroxide suspension.

12. The method of claim 1, further comprising milling the manganese hydroxide while the manganese hydroxide is in the manganese hydroxide suspension to obtain a manganese hydroxide particle size of 10 μm or less before adding the suspension to the alkali metal hydroxide to form the second aqueous solution.

13. The method of claim 1, further comprising:
separating the oxide of manganese from the second aqueous solution; and
drying the oxide of manganese.

14. The method of claim 13, further comprising using an acid to neutralize the oxide of manganese separated from the second aqueous solution.

15. The method of claim 13, wherein the drying is conducted in air at a temperature of 80-180° C.

16. The method of claim 13, wherein the dried oxide of manganese comprises birnessite, a maximum of 20% hausmannite, and a maximum of 10% feitknechtite.

17. The method of claim 13, wherein the dried oxide of manganese further comprises a maximum of 400 ppm of anions.

18. The method of claim 13, wherein the dried oxide of manganese has a specific surface area of at least 25 m²/g.

19. A dried oxide of manganese comprising birnessite, a maximum of 20% hausmannite, and a maximum of 10% feitknechtite.

20. The dried oxide of manganese of claim 19, further comprising a maximum of 400 ppm of anions.

21. The dried oxide of manganese of claim 19 having a specific surface area of at least 25 m²/g.

22. The dried oxide of manganese of claim 19, wherein the average oxidation state is greater than 3.5.

23. The dried oxide of manganese of claim 19, further comprising sodium.

24. The dried oxide of manganese of claim 20, wherein the anions are at east one of nitrate, sulfate, and chloride.
